(19) United States
(12) Patent Application Publication
(10) Pub. No.: US 2005/0262395 A1
(43) Pub. Date: Nov. 24, 2005

(54) Transmission device, control method thereof and communication system utilizing the same

(75) Inventors: Shih-Yun Yang, Tao Yuan Shien (TW); Ching-Chih Shih, Tao Yuan Shien (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Quanta Computer Inc.

(21) Appl. No.: 11/067,775

(22) Filed: Feb. 28, 2005

(30) Foreign Application Priority Data
May 4, 2004 (TW) 93112489

(51) Int. Cl. G06F 11/00

(52) U.S. Cl. 714/25; 714/43

(57) ABSTRACT

A communication system. The system includes a transmission bus, a plurality of circuit apparatuses, and a management device. Each circuit apparatus comprises an external integrated circuit and a switch circuit. Each external integrated circuit is coupled to the transmission bus via the corresponding switch circuit. The management device monitors the status of the transmission bus and, when the status is determined as abnormal, switches at least one of the switch circuits to isolate at least one corresponding external integrated circuit from the transmission bus.

### BACKGROUND

The present invention relates to a transmission device, and more particularly to a transmission device for protecting a transmission bus of a communication system and a control method thereof.

Computer systems comprise many integrated circuits (ICs), such as microprocessors, random access memories (RAMs), electrically erasable programmable read only memories (E²PROMs), liquid crystal display (LCD) drivers, or data converters. These ICs transmit data through a bus, such an as an inter-integrated circuit (I²C) bus.

FIG. 1 is a schematic diagram of a conventional I²C connecting integrated circuits. Integrated circuits (ICs) 11˜14 transmit data through the I²C bus 15. Only utilizing clock signal SCL and data signal SDA is characteristic of the I²C bus 15.

In an I²C bus, only one IC is designated as a master for controlling the clock signal SCL and others are designated as slave ICs. The master IC is unfixed such that each IC can be designated as a master IC.

If the IC 11 is designated as a master, ICs 12-14 serve as slave ICs. Some factors, such as element aging, may cause the IC 11 abnormal such that the IC 11 outputs an incorrect clock signal SCL to hold the I²C bus 15. Therefore, ICs 11˜14 cannot transmit data to each other and the computer system paralysis causes shutdown.

In actual operation, since many ICs are connected via the I²C bus 15, when the status of one IC is abnormal, a user cannot easily and directly find the abnormal IC. A conventional solution has been developed. First, a user opens a computer case and then finds the I²C bus. Next, the ICs are pulled by the user.

When pulling out one IC, a user must test the operation of the I²C bus. If the I²C bus is still paralyzed, a user must continue pulling out other ICs until the paralysis is eliminated. If the number of abnormal ICs exceeds one, the user must insert the removed ICs and then pull the ICs out one by one, until all the abnormal ICs are found. This conventional solution is costly, time consuming and requires human intervention.

### SUMMARY

Embodiments of the invention provide a communication system comprising a transmission bus, a plurality of circuit apparatuses and a management device. Each circuit apparatus comprises an external integrated circuit and a switch circuit. Each external integrated circuit is coupled to the transmission bus via the corresponding switch circuit. The management device monitors the status of the transmission bus. When the status of the transmission bus is determined as abnormal, the management device switches at least one of the switch circuits to isolate at least one corresponding external integrated circuit from the transmission bus.

Also provided is a transmission device transmitting data between a plurality of external integrated circuits. The transmission device comprises a transmission bus, a plurality of external connectors, and a management device. Each external connector comprises a slot and a switch circuit. Each external integrated circuit is able to couple to the transmission bus via one slot and the corresponding switch circuit. The management device monitors the status of the transmission bus. When the status of the transmission bus is determined as abnormal, the management device switches at least one of the switch circuits to isolate at least one corresponding external integrated circuit from the transmission bus.

An embodiment of the invention additionally provides a control method, appropriate for a communication system comprising a transmission bus and a plurality of integrated circuits. A plurality of switch circuits are provided. Each switch circuit connects between the transmission bus and a corresponding integrated circuit. The status of the transmission bus is monitored. At least one switch circuit is switched to isolate at least one corresponding integrated circuit from the transmission bus and to retrieve a failed integrated circuit when the status is determined as abnormal.

### BRIEF DESCRIPTION OF THE DRAWINGS

The invention can be more fully understood by reading the subsequent detailed description and examples with reference made to the accompanying drawings, wherein:

FIG. 1 is a schematic diagram of a conventional I²C connecting integrated circuits;

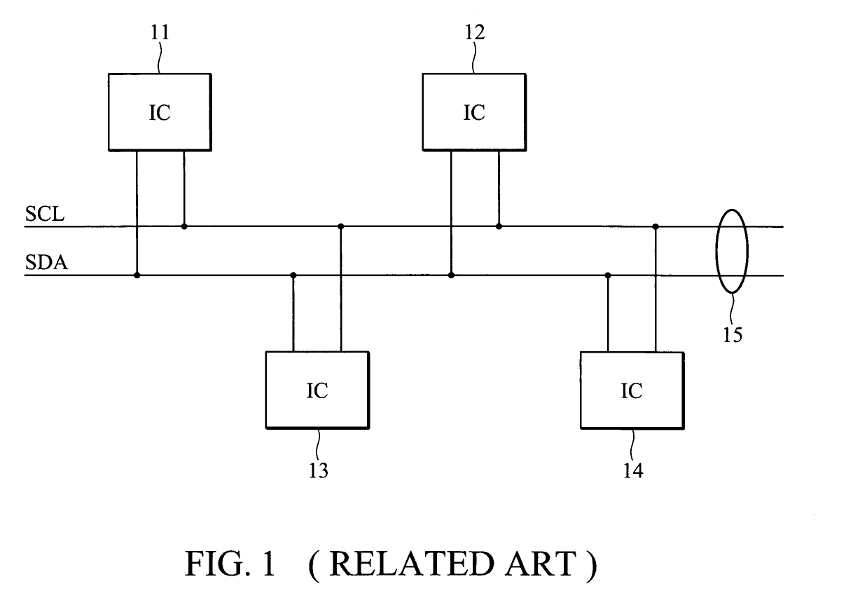

FIG. 2 is a schematic diagram of a communication system according to an embodiment of the invention;

FIG. 3 shows a control method of a computer system according to an embodiment of the invention.

### DETAILED DESCRIPTION

A bus interface, such as a system management bus (SM Bus), a universal controller interface bus (USB), a IEEE1394, a peripheral controller interface bus (PCI Bus), and an I²C bus, can be applied in the invention. Hereinafter, an I²C bus is given as an example.

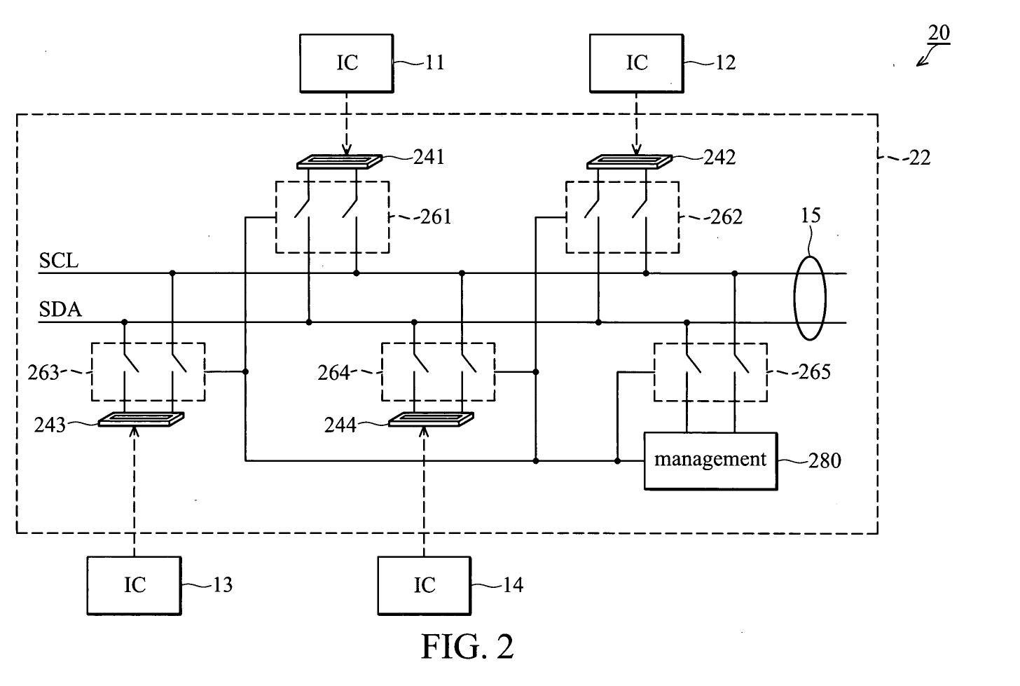

FIG. 2 is a schematic diagram of a communication system according to an embodiment of the invention. The communication system 20 comprises integrated circuits (ICs) 11˜14 and a transmission device 22. ICs 11˜14 transmit data through the transmission device 22.

The transmission device 22 comprises an I²C bus 15, slots 241˜244, switch circuits 261˜265, and a management device 280. ICs 11˜14 can be inserted into slots 241˜244 to connect with the I²C bus 15 through switch circuits 261˜265, respectively.

The management device 280 is connected with the I²C bus 15 through switch circuit 265 for monitoring the status of the I²C bus 15 and switching the switch circuits 261˜265. Since the management device 280 continuously or periodically monitors the status of the I²C bus 15, the switch circuit 265 is generally turned on. The I²C bus 15 is coupled to terminals of the ICs 11˜14, transmitting the clock signal SCL and data signal SDA.

When the management device 280 determines the status of the I²C bus 15 as abnormal, for example the voltage level of the clock signal SCL or data signal SDA has not been changed during a preset time or the ICs are unable to transmit data through the I²C bus 15, the management device 280 switches the switch circuits 261˜264 individually to isolate a corresponding IC from the I²C bus 15. Once one of switch circuits 261˜264 is turned off and the I²C bus 15 is normal, it may be concluded that a corresponding isolated IC has failed. A failed IC can be isolated, in order to not disturb the signal transmission of others.

When the switch circuits 261˜264 are all turned off and the status of the I²C bus 15 is abnormal, it is possible that the root cause of abnormality is in the management device 280 or I²C bus 15 itself. Thus, the switch circuit 265 can be turned off and if the ICs 11˜14 are still unable to transmit data through the I²C bus 15, it can be determined that the failed has occurred in the I²C bus 15.

When the failed factor is detected, the management device 280 generates a warning signal, such as an alarm or a catchphrase, to notify user of the failed.

If a failed IC has been isolated from the I²C bus 15, the operation of the I²C bus 15 should resume normal operation even if the user does not immediately remove the abnormal IC. Additionally, the I²C bus 15 of the present invention has a hot-swap function such that a user can immediately swap the failed IC when it is detected.

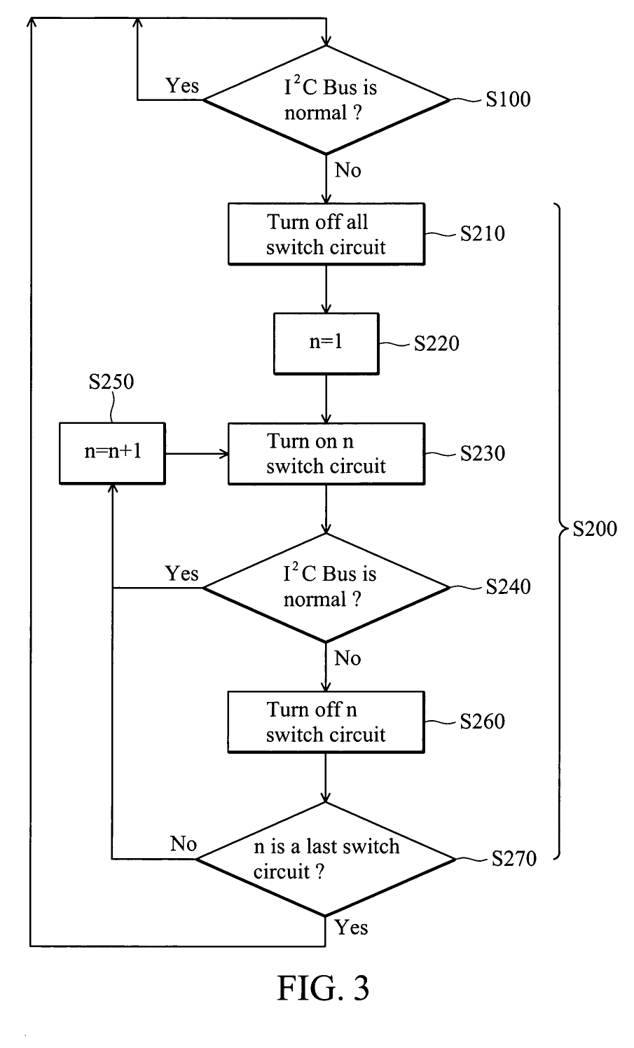

The operating principle of the management device 280 is shown in FIG. 2 and described in the following. FIG. 3 shows a control method of a communication system according to an embodiment of the invention. The ICs 11˜14 are inserted into the slots 241˜244, respectively. The switch circuits 261˜265 are initially turned on.

First, the management device 280 monitors the status of the I²C bus 15 in step 100. If the status of the I²C bus 15 is normal, the ICs 11˜14 may transmit data to each other. After another period of time, the management device 280 monitors the status again.

When the status of the I²C bus 15 is monitored as being abnormal, the communication system is determined as being blocked. The management device 280 begins to switch the switch circuits 261˜264 to locate and isolating a failed IC in step 200.

In step 210, the management device 280 turns off all switch circuits 261˜264 for isolating the ICs 11˜14 from the I²C bus 15 such that the status of the I²C bus 15 is again normal.

Following step 210, if I²C bus 15 becomes normal, the management device 280 detects the first IC, and a parameter n is set to 1 in step 220. The management device 280 turns on first switch circuit 261 in step 230 for connecting the first IC with the I²C bus 15. The management device 280 monitors the status of the I²C bus 15 in step 240. If the status of the I²C bus 15 is still normal, the management device 280 increases the parameter n in step 250 and turns on the next switch circuit in step 230. From parameter n, the management device 280 or a system supervisor can determine which switch circuit is being switched and make record if needed.

Every time when one switch circuit is turned on, the corresponding IC is connected to the I²C bus 15 and the management device 280 then monitors the status of the I²C bus 15. If the status of the I²C bus 15 becomes abnormal due to the newly-added connection, the management device 280 turns off the switch circuit for isolating the corresponding IC in step 260, in order to maintain the normal status of the I²C bus 15.

Finally, the management device 280 detects whether the last switch circuit has been switched in step 270. If the last switch circuit has been switched, the management device 280 stops controlling the switch circuits and the process returns to step 100. If the last switch circuit is not switched, the management device 280 increases the parameter n in step 250 for turning on the next switch circuit.

For example, in FIG. 2, ICs 11˜14 are connected to the I²C bus 15, a failure occurs in the IC 13, and the status of the I²C bus 15 is abnormal.

When the abnormal status is detected by the management device 280, switch circuits 261˜264 are turned off causing the status of the I²C bus 15 to recover normal status. The management device 280 then sequentially turns on switch circuits 261˜264. The management device 280 detects the status of the I²C bus 15 each time a switch circuit is turned on. When the switch circuit is turned on and the status of the I²C bus 15 is still normal, the management device 280 continues to turn on another switch circuit.

Since the IC 13 has failed, when the management device 280 turns on the switch circuit 263, the I²C bus 15 becomes abnormal and this abnormality can be detected by the management device 280. Accordingly, the management device 280 turns off the switch circuit 263. When the failed IC is isolated, the status of the I²C bus 15 must turn back to normal. After the management device 280 turns on the switch circuit 264, data can be transmitted in the I²C bus 15.

In addition to the described sequential search method, the management device 280 can utilize a binary search method to select switch circuits. First, the switch circuits are divided into two groups. One group is turned off and the other is turned on. If the status of the I²C bus 15 is detected as normal, a failed IC in the group must be turned off. If the status of the I²C bus 15 is abnormal, the failed IC is in the turned on group.

To allocate the failed IC, the group causing the abnormal status is further divided into two sub-groups. The management device 280 continues to detect which sub-group is causing the communication system to fail. This binary search method can narrow the detection range. Finally, when a group has only one switch circuit, the failed one is located.

Advantages of embodiments of the invention are summarized in the following. First, the invention controls switch circuits and auto-detects the status of the bus such that the failed IC is located. Embodiments of the invention can shorten detection time and reduce cost by utilizing different control methods. Second, when the failed IC is located, the failed IC can be isolated from the bus, allowing the bus to again function normal. Third, since the invention auto-isolates the failed IC, a user need not remove the failed IC immediately and the bus is available.

While the invention has been described by way of example and in terms of the preferred embodiments it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A communication system comprising:
a transmission bus;
a plurality of circuit apparatuses electrical connecting the transmission bus, each of the circuit apparatuses comprising an external integrated circuit and a switch circuit, wherein the external integrated circuit is coupled to the transmission bus via the corresponding switch circuit; and
a management device electrical connecting and monitoring a status of the transmission bus and, when the status of the transmission bus is abnormal, the management device switching at least one of the switch circuits and isolating the corresponding external integrated circuit from the transmission bus until finding which one of the circuit apparatuses is failed.

2. The communication system as claimed in claim 1, wherein each circuit apparatus comprises a slot connected between one external integrated circuit and the corresponding switch circuit.

3. The communication system as claimed in claim 1, wherein after switching one of the switch circuits, the management device detects whether the abnormality is caused by the isolated external integrated circuit.

4. The communication system as claimed in claim 3, wherein when the abnormality is determined as being caused by the isolated external integrated circuit, the management device keeps the one of the switch circuits turned off to disconnect the isolated external integrated circuit from the transmission bus.

5. The communication system as claimed in claim 1, wherein the transmission bus is an inter integrated circuit (I²C) bus.

6. The communication system as claimed in claim 5, wherein the management device monitors the status of the I²C bus according to data signal on the I²C bus.

7. The communication system as claimed in claim 5, wherein the management device monitors the status of the I²C bus according to clock signal on the I²C bus.

8. The communication system as claimed in claim 1, wherein the management device switches the switch circuits according to a binary search method.

9. The communication system as claimed in claim 1, wherein when the status is determined as abnormal, all the switch circuits are turned off and then sequentially turned on to check whether the abnormality still remains and to retrieve a failed external integrated circuit.

10. A transmission device for transmitting data between a plurality of external integrated circuits, the transmission device comprising:
a transmission bus;
a plurality of external connectors electrical connecting the transmission bus, each of the external connectors comprising a slot and a switch circuit, wherein the external integrated circuit is able to couple to the transmission bus via the slot and the corresponding switch circuit; and
a management device electrical connecting and monitoring a status of the transmission bus and, when the status is abnormal, the management device switching at least one of the switch circuits and isolating the corresponding external integrated circuit from the transmission bus until finding a failed external integrated circuit.

11. The transmission device as claimed in claim 10, wherein the transmission bus is an inter integrated-circuit (I²C) interface.

12. The transmission device as claimed in claim 11, wherein the management device monitors the status of the I²C bus according to data signal on the I²C bus.

13. The transmission device as claimed in claim 11, wherein the management device monitors the status of the I²C bus according to clock signal on the I²C bus.

14. The transmission device as claimed in claim 10, wherein the management device switches the switch circuits according to a binary search method.

15. The transmission device as claimed in claim 10, wherein when the status is determined as abnormal, all the switch circuits are turned off and then sequentially turned on to check whether the abnormality still remains and to retrieve a failed external integrated circuit.

16. A control method, appropriate for a communication system comprising a transmission bus and a plurality of integrated circuits, the control method comprising the steps of:
providing a plurality of switch circuits, each connected between the transmission bus and the corresponding integrated circuit;
monitoring a status of the transmission bus; and
switching at least one of the switch circuits to isolate at least one corresponding integrated circuit from the transmission bus and to retrieve a failed integrated circuit when the status of the transmission bus is determined as abnormal.

17. The control method as claimed in claim 16, further comprising a step of providing a management device for controlling all switch circuits.

18. The control method as claimed in claim 17, further comprising the following step:
when the failed integrated circuit is retrieved by the management device, keeping the switch circuit corresponding to the failed integrated circuit turned off.

19. The control method as claimed in claim 16, wherein the switching step further comprises the following steps:
turning off all switch circuits; and
sequentially turning on all switch circuits and monitoring the status of the transmission interface to retrieve a failed integrated circuit.

20. The control method as claimed in claim 16, wherein the switch circuits are switched by a binary search method.

21. The control method as claimed in claim 16, wherein the status of the transmission bus is monitored according to data signal on the transmission bus.

22. The control method as claimed in claim 15, wherein the status of the transmission bus is monitored according to clock signal on the transmission bus.
